(19) United States
(12) Patent Application Publication
(10) Pub. No.: US 2007/0103418 A1
(43) Pub. Date: May 10, 2007

(54) Image displaying apparatus

(76) Inventors: Masahiro Ogino, Yokohama (JP); Nobuaki Kabuto, Kunitachi (JP); Kikuo Ono, Mobara (JP); Ikuko Mori, Chiba (JP); Yoshihisa Ooishi, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/586,543

(22) Filed: Oct. 26, 2006

(30) Foreign Application Priority Data
Nov. 9, 2005 (JP) 2005-324277

(51) Int. Cl. G09G 3/36

(52) U.S. Cl. 345/89

(57) ABSTRACT

An image displaying apparatus, for improving motion blur, in particular, on an image displaying apparatus of hold-type, such as, a liquid crystal display element, etc., comprising: sub-frame producing portions (5, 6) for producing a first sub-frame, a second sub-frame being lower in the gradation than the first sub-frame, from an image of one (1) frame of an image signal inputted; a histogram detection portion (2) for detecting brightness histogram of the image signal; an image determination portion (3) for determining on whether the image signal inputted is a high-gradation image or not, from that brightness histogram; and a level compensation portion (4) for lowering a gradation level of that image signal inputted. And, according to the present invention, lowering the gradation of the high-gradation image keeps the difference in brightness between the first and the second sub-frames, and thereby increasing an effect of improving the motion blur.

### BACKGROUND OF THE INVENTION

(1) Filed of the Invention

The present invention relates to an image displaying apparatus, using a hold-type display element therein, such as, a liquid crystal display element or the like, for example.

(2) Description of the Related Art

Differing from an impulse-type, such as, a CRT, the hold-type display element, for example, a liquid crystal display element holds video data for each of pixels, during term of one (1) frame. For this reason, in case when displaying a moving picture on such the display element, a phenomenon of becoming dim on the contour or outline of an image (hereinafter, being called by “motion blur”) is generated, and this is visually recognized as an afterimage or incidental image for a user.

The technology for improving such motion blur is already known, for example, in Japanese Patent Laying-Open No. 2005-173573 (2005). Thus, in the column [0102] of the Japanese Patent Laying-Open No. 2005-173573 bulletin, and in FIG. 11, there is disclosed the improvement of the motion blur, by shortening a holding time of holding the same image data, i.e., conducting the image display while dividing the one (1) frame period into plural numbers of sub-frame periods, each of which differs from each other in gradation. The gradation level of each of the sub-frames is determined on the gradation level of an image signal inputted.

### SUMMARY OF THE INVENTION

The sub-frame mentioned above includes a first sub-frame and a second sub-frame, which is lower in gradation than that first sub-frame, for example. The respective gradations of those first and second sub-frames are so determined that they are equal to the gradation of an original frame, upon which they are generated, when both of them are synthesized or composed. For example, in case where the original frame has 100 gradations (the maximum 255 gradations by expression of eight (8) bits), the first sub-frame is set at 137 gradations while the second sub-frame at 32 gradations.

In this instance, the lower the gradation of the second sub-frame (i.e., the nearer to black), the larger the effect of improving the motion blur. Accordingly, in case where the gradation of the original frame lies from a low gradation to a middle gradation, it is possible to lower the gradation of the second sub-frame, and therefore the effect of improving the motion blur comes to be large.

However, the gradation of the first frame is restricted up to the maximum gradation (for example, 255 gradations), in case where the gradation of the original frame is high gradation, then it is difficult to lower the second sub-frame. For example, in case where the original frame is 220 gradations, then the first sub-frame is set at 255 gradations, and the second sub-frame at 114 gradations. Therefore, with the conventional art, the effect comes to be small of improving the motion blur.

Also, when displaying the sub-frame, which is obtained from the image signal of 2-3 pull-down or 2-2 pull-down, for example, a dark sub-frame is inserted once when switching from the original frame indicative of a certain image content to the original frame indicative of other image content. For this reason, there are cases where emphasis is made upon flicker and/or motion judder (i.e., obstruction of loosing the smoothness of motions), to be recognized, in particular, at that switched portion. That switched portion mentioned above indicates a portion where the frame is changed from “A” to “B” on the 2-3 pull-down image signal, continuing or repeating the original frame of indicating a certain image content “A” by two (2) times, such as, “A” and “A”, and next continuing or repeating the original frame of indicating other image content “B” by three (3) times, such as, “B”, “B” and “B”, for example.

Then, the present invention, accomplished by taking the drawback of the conventional art mentioned above into the consideration thereof, an object thereof is to provide a technology for displaying a high-quality image, which is improved in the motion blur on the motion video. Also, the present invention enables to display the image signal of pull-down method with high quality while improving the motion blur mentioned above.

The present invention is characterized in that, when the gradation of the image signal inputted is equal or greater than a predetermined value, the gradation level of said image signal inputted is so compensated that it is lowered down, and from the image signal, upon which the compensated is made on the gradation thereof, first and second sub-frames are produced. In this instance, it is preferable to increase or heighten an intensity of illumination from a light source (i.e., a backlight) of a liquid crystal displaying element, thereby compensating for lowering of the gradation mentioned above.

It is determined on whether the image signal inputted is the image of high-gradation or not, by a histogram indicative of frequency of appearances for each of plural numbers of gradation areas during a predetermined time-period, which is detected from the image signal inputted. Also, the determination mentioned above may be made from an averaged brightness level (APL) during a predetermined time-period, or those may be used in combination.

Also, according to the present invention, when producing the sub-frames from the image signal of pull-down method, it is characterized in that the gradation levels between the sub-frames at an exchange portion of the frame of the image signal inputted being equal to each other.

Thus, according to the present invention, it is possible to display the high-quality image or picture, by improving the motion blur, preferably, within the image displaying apparatus, applying the display element of the hold-type, such as, the liquid crystal displaying element, for example. Also, it is possible to display the image signal of the pull-down method, reducing the flicker and the motion judder thereof.

### BRIEF DESCRIPTION OF THE DRAWINGS

Those and other objects, features and advantages of the present invention will become more readily apparent from the following detailed description when taken in conjunction with the accompanying drawings wherein:

FIG. 1 is a block diagram for showing a first embodiment of the present invention;

FIG. 2 is a view for showing gradation converting characteristics of each of sub-frames within a gradation conversion portion 6;

FIG. 3 is also a view for showing gradation converting characteristics of each of sub-frames with in a gradation conversion portion 6;

FIG. 4 is a view for showing an example of the structures of a level compensation portion 4 in the first embodiment;

FIGS. 5(a) and 5(b) are views for showing the characteristics of a black level compensation amount;

FIGS. 6(a) and 6(b) are views for showing the characteristics of a light source compensation amount;

FIG. 7 is a view for showing a concept of the black level compensation and the light source control in the first embodiment;

FIG. 8 is a view for showing an example of the structures of a level compensation portion 4 in a second embodiment of the present invention;

FIG. 9 is a view for showing a concept of black defacing by the black level compensation;

FIG. 10 is a view for showing a concept of gradation compensation in the second embodiment;

FIG. 11 is a view for showing a concept of gradation control compensation portion 121 in the second embodiment;

FIG. 12 is a block diagram for showing a third embodiment of the present invention;

FIG. 13 is a view for showing an example of a raw of sub-frame, which is produced in the third embodiment;

FIG. 14 is also a view for showing an example of a raw of sub-frame, which is produced in the third embodiment;

FIG. 15 is a view for showing an example of a raw of sub-frame, which is produced in the third embodiment;

FIG. 16 is a view for showing an example of a raw of sub-frame, which is produced in the third embodiment; and

FIG. 17 is a view for showing the gradation converting characteristics of the sub-frame in the third embodiment.

### DETAILED DESCRIPTION OF THE INVENTION

Hereinafter, embodiments according to the present invention will be fully explained by referring to the attached drawings. However, explanations of the following embodiments, which will be mentioned below, are made on, for example, an image displaying apparatus using a liquid crystal display element, as the image displaying element thereof. But, the present is also applicable onto a display element other than the liquid crystal display element, such as, an EL display element, etc., for example, as far as it is the display element of the hold-type mentioned above.

### Embodiment 1

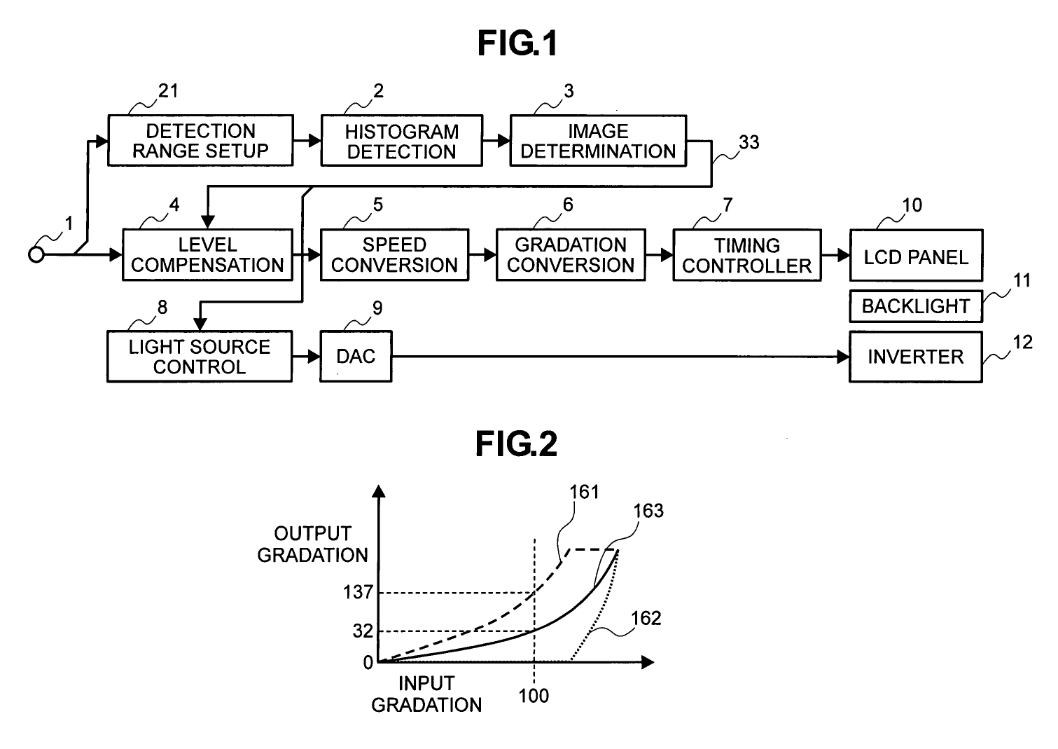

FIG. 1 is a block diagram for showing an example of the structures of a first embodiment, an image displaying apparatus according to the present invention. In the present embodiment, it is assumed that an image signal of a component format (YcbCr format) having a frame frequency of 60 Hz is inputted from an input terminal 1. The image signal inputted at the input terminal 1 is supplied to a level compensation portion 4. And, that image signal inputted is also supplied to a histogram detection portion 2 through a detection range setup portion 21. The detection range setup portion 21 is provided for setting up the range of brightness histogram, which is detected by the histogram detection portion, within one (1) piece of screen of the image (the details of which will be mentioned later). The histogram detection portion 2 detects the brightness histogram during a period of one (1) frame or one (1) field, for example, from a brightness signal (Y) included within the image signal inputted. This brightness histogram indicates a frequency of appearance of the brightness signal, corresponding to each one of the gradation areas divided into plural numbers, respectively. For example, in the case where the image signal inputted is a digital signal of eight-bits (8-bits) and the number of gradations thereof is 256, the gradation areas within the brightness histogram are divided into 8 to 16 pieces for every 32 gradations, for example. And, for each of the areas divided, counting is made upon the number of pixels of the brightness signals, each having the level belonging to (or included in) that gradation area, as the frequency of appearance, during the period of one (1) frame or one (1) field. In this manner, the brightness histogram is produced. However, in the explanation given below, it will be made assuming that the input image is explained to have the maximum gradation of 225.

The brightness histogram, which is produced within the histogram detection portion 2 mentioned above, is supplied to an image determination portion 3. The image determination portion 3 determines on whether it is the high-gradation image or not, i.e., there are the pixels by a predetermined number thereof or not, within the area where the gradation is equal or higher than a predetermined one (for example, 190 gradations). When determining that the image signal inputted is the high-gradation image, as a result of this determination, the image determination portion 3 supplied a control signal 33 to the level compensation portion 4 and also a light source control portion 8.

The level compensation portion 4 compensates the gradation level of the image signal provided at an input terminal 1, depending upon the control signal provided from the image determination portion 3. In case when the control signal is outputted from the image determination portion 3, the level compensation portion 4 control the gradation of the image signal to be lowered down. The image signal, the gradation of which is compensated within the level compensation portion 4, is inputted into a duplicate-speed conversion portion 5, and in this duplicate-speed conversion portion 5, it is converted into two (2) times larger in the frame frequency thereof. The frame frequency of the image signal inputted is 60 Hz in the present example, as was mentioned above, therefore the duplicate-speed conversion portion 5 converts it into 120 Hz, being two (2) times larger thereof. The duplicate-speed conversion portion 5 repeats the same frame, for example, by two (2) times, so as to duplicate the frame frequency. In case where an original frame of the image signal inputted appears at a period of 1/60 sec., such as, “A”, “B” , “C” . . . , for example, then the duplicate-speed conversion portion 5 converts this into a signal appearing at a period of 1/120 sec., such as, “A”, “A”, “B”, “B”, “C” , “C” . . . .

A gradation conversion portion 6 conducts a gradation conversion process onto the image signal, which is duplicated in the speed within the duplicate-speed conversion portion 5. Herein, it is assumed, between two (2) pieces of the same frames, which are produced within the duplicate-speed conversion portion 5 mentioned above, that the frame appearing at first is a first (1^{st}) sub-frame and that appearing thereafter is a second (2^{nd}) sub-frame. And, the gradation conversion portion 6 conducts the gradation conversion, such that the gradation of the first sub-frame is higher than that of the original frame (i.e., brighter) while the gradation of the second sub-frame is lower than that of the original frame (i.e., darker). Thus, the gradation of the second sub-frame is lowered down that that of the first sub-frame.

Explanation will be given on an example of the gradation conversion process, which is conducted within the gradation conversion portion 6, by referring to FIG. 2 attached herewith. This FIG. 2 shows characteristics of the gradation conversion within the gradation conversion portion 6, wherein a curve 161 indicates the conversion characteristic onto the first sub-frame, while a curve 162 indicates the conversion characteristic onto the second sub-frame. And, a curve 163 indicates the characteristic curve when composing the first sub-frame and the second sub-frame (i.e., an ideal output gradation: a curve of γ=2.2 in the figure). In case when the original frame of 100 gradations is inputted into the gradation conversion portion 6 having such characteristics as was mentioned above, the first sub-frame is converted to that of 137 gradations, in accordance with the curve 161, while the second sub-frame is converted into 0 gradation (i.e., black) in accordance with the curve 162.

And, the gradation of that composing the first sub-frame and the second sub-frame comes to have 32 gradations in accordance with the curve 163. Herein, assuming the gradation of the input image is “Tin”, the maximum gradation “Tmax”, the gradation of the first sub-frame “T1st” and the gradation of the second sub-frame “T2nd”, respectively, then an equation for calculating the gradation is as the following equation (Eq. 1):
(Tin/Tmax)^{2.2}={(T1st/Tmax)^{2.2}+(T2nd/Tmax)^{2.2}}/2 (Eq. 1)
Thus, the gradations of the first sub-frame and the second sub-frame are so determined that they follow the equation mentioned above.

After being conducted with the gradation conversion as was mentioned above, the first sub-frame and the second sub-frame are supplied to a timing controller 7. This timing controller 7 supplies the image data of the first and second sub-frames to a LCD panel 10, upon basis of a horizontal synch signal and a vertical synch signal, which are inputted together with the image signal inputted. Of course, a vertical scanning frequency of the image data, which is supplied to the LCD panel 10 is duplicated (two (2) times larger) of the vertical scanning frequency of the image signal inputted. In this manner, the bright first sub-frame and the dark second sub-frame are displayed, alternately, on the LCD panel 10.

In this manner, according to the present embodiment, the image data of two (2) frames, such as, of the first sub-frame and the second sub-frame, are written into the LCD panel 10, during the time-period of the normal one (1) frame. For this reason, the driving frequency of the LCD panel 10 comes to duplicated (two-times larger) than the normal one. And, during the time-period of the first sub-frame, the data brighter than that of the image signal inputted are written into, while during the time-period of the second sub-frame, the data as near to zero (0) as possible (i.e., black) is written in. Accordingly, it is possible to achieve an effect of improving the blur, being equal to that with the method of inserting a black image during the time-period of one (1) frame (i.e., so-called a black insertion), without lowering the brightness thereof. Hereinafter, such the method will be called by a “gradation distributing method”.

On the other hand, within the light source control portion 8, an amount of setting up the light source voltage is calculated out, depending on the control signal 33 outputted from the image determination portion 3, to be outputted to a DAC 9. In this DAC 9, DC voltage is produced depending upon the amount of setting up the light source voltage, to be outputted to an inverter 12. The inverter 12 produces a PWM signal upon basis of the DC signal supplied from the DAC 9, so as to conduct current control of a backlight 11, as being a light source of the LCD 10; thereby controlling an intensity of illumination (or illuminance) from the backlight 11. Herein, the backlight 11 may be a white color light source, or may be made up with a plural number of LED lights irradiating plural numbers of colors therefrom.

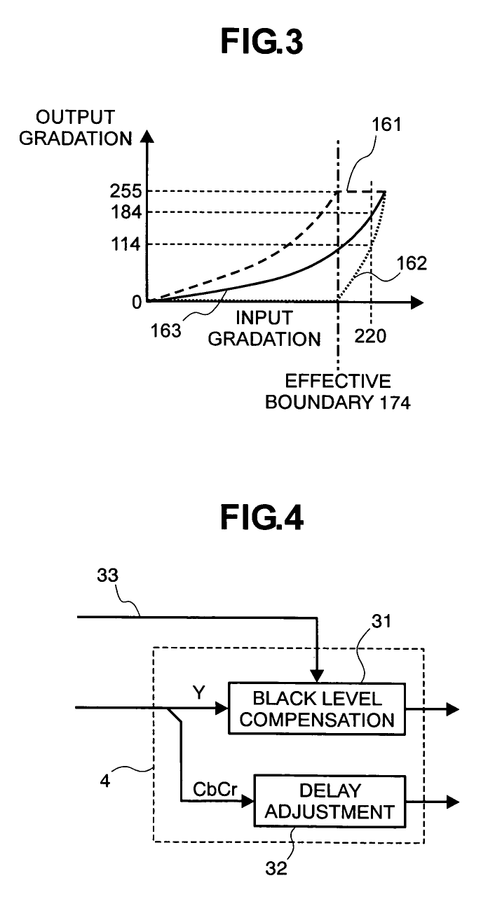

In such the gradation distributing method as was mentioned above, as is shown in FIG. 3, for example, the conversion characteristic 162 of the second sub-frame depicts a characteristic curve increasing sharply, when the gradation of the image signal inputted is equal or larger than a predetermined gradation 174 (herein after, being called by “effective boundary”. For this reason, in case when the gradation of the image signal inputted has a high gradation exceeding the effective boundary 174, it is impossible to lower the gradation of the image signal inputted. In case when the image signal inputted has 220 gradations, for example, as is shown in FIG. 3, the gradation of the second sub-frame is 144, i.e., relatively high gradation. For this reason, it is impossible to insert a frame near to black during the period of the second sub-frame, and therefore lessens the effect of improving the motion blur. Namely, on the boundary 174, the effect of improving the motion blur is reduced, when inputting the image signal having the gradation larger than that. However, this effective boundary 174 is about 190 gradations, in case when inputting the 8-bits data and γ=2.2, for example.

For improving this, according to the present embodiment, it is characterized that the control is so made that the gradation of the image signal inputted is lowered down, in case when the image signal inputted has the high gradation exceeding the predetermined gradation (i.e., the effective boundary). The predetermined gradation is set at around 190 gradations, where the effect of improving the motion blur is reduced, as was mentioned above, for example. Hereinafter, explanation will be made on the operations when the image signal inputted is the high-gradation image mentioned above.

The image determination portion 3 determined on whether the image signal inputted is the high-gradation image or not, with using the brightness histogram, which the histogram detection portion 2 produces. For example, an appearance frequency (i.e., the number of pixels), belonging to the brightness area being equal or greater than the effective boundary 174 within the brightness histogram mentioned above, is equal or greater than 50% of all over the pixels, then the said image signal inputted is determined to be the high-gradation image. Then, the image determination portion produces the control signal 33, as was mentioned above, to be outputted to the level compensation portion 4 and the light source control portion 8.

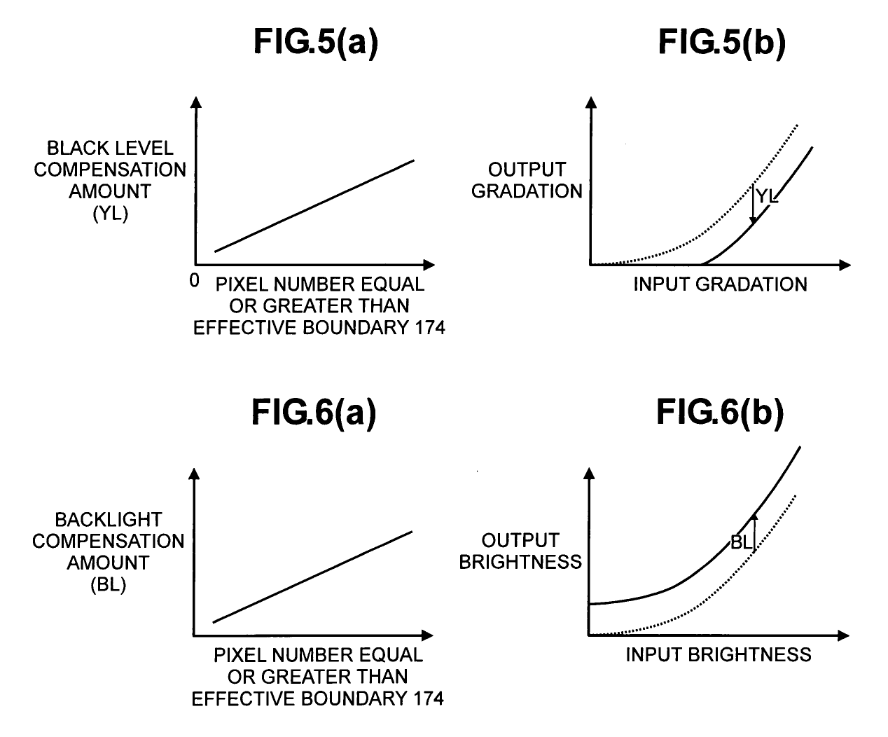

Explanation will be made on the operations of the level compensation portion 4 and the light source control portion 8, within the present embodiment, by referring to FIGS. 4 and 5. FIG. 4 is a block diagram for showing an example of the structures of the level compensation portion 4. The level compensation portion 4, according to the present embodiment, includes a black level compensation portion 31 and a delay adjustment portion 32. The control signal 33 mentioned above is supplied to the black level compensation portion 31, as a level compensation volume or amount. The black level compensation portion 31 controls the black level (i.e., DC level) of the image signal, depending upon the level compensation amount mentioned above. In the example shown in FIG. 4, the level compensation is treated only upon the brightness signal (Y), while conducting only delay upon a chromatic signal (CbCr) for fitting with the brightness signal, in the structures thereof. But, in the structures, a similar process may be treated upon the chromatic signal (CbCr). Within the black compensation portion 31 is conducted a process for lowering the black level (i.e., DC level) of the image signal. FIGS. 5(a) and 5(b) show an example of the characteristic curves of the level compensation amount 33 mentioned above. As is shown in FIG. 5(a), the larger in the number of pixels being equal or greater the effective boundary 174, the larger in the black level compensation amount, i.e., the lowering width (YL) of the black level. Thus, the black level compensation amount (YL) is nearly proportional to the number of pixels being equal or greater than the effective boundary 174. For this reason, as is shown in FIG. 5(b), the gradation of the image signal, which is outputted from the black level compensation portion 31, is lowered down by the black level compensation amount (YL), comparing to the gradation of the image signal inputted into the black level compensation portion 31.

Accordingly, the high-gradation image exceeding the effective boundary 174 shown in FIG. 3 is compensated into an image having the gradation being equal or less that the effective boundary 174, by means of the black level compensation portion 31. As a result thereof, it is possible to lower the total gradation of the image signal, which is inputted into the gradation conversion portion 6, to be equal or lower than effective boundary 174, substantially. Therefore, for the gradation conversion portion 6, it is possible to lower the gradation of the second sub-frame, which is produced from that high-gradation image, down to zero (0) (i.e., black), as shown in FIG. 3, even in case when the image signal inputted is the high-gradation image. Thus, according to the present embodiment, it is possible to increase the effect of improving the motion blur, when the image signal inputted is the high-gradation image, within the gradation distributing method.

However, in the case mentioned above, since the gradation of the image signal is lowered, then the brightness of the image displayed on the LCD panel is also lowered down. According to the present embodiment, for the purpose of compensating of reduction in the brightness, control is made upon the intensity of illumination of the light irradiated from the backlight 11, as being the light source of the LCD pane 110. Namely, when the gradation of the image signal inputted is lowered down by means of the level compensation portion 4, such control is made that the intensity of illumination is heighten on the light irradiated from the backlight 11. An example of this control characteristic is shown in FIGS. 6(a) and 6(b). As shown in FIG. 6(a), the control is so made that the larger the number of pixels being equal or larger than the effective boundary 174, the greater the backlight compensation amount, e.g., an increasing width (BL) of the intensity of illumination of the backlight comes to be large effective boundary 174. In other words, the increasing width (BL) of the intensity of illumination of the backlight is nearly proportional to the number of pixels being equal or greater than the effective boundary 174. For this reason, as is shown in FIG. 6(b), the brightness of the image displayed on the LCD panel 11 is heighten by the increasing width (BL) mentioned above.

However, in the present embodiment, the level compensation of the image signal mentioned above and the light source control are operated in linkage. Therefore, the backlight compensation amount (BL) may be controlled in combination with the compensation amount (YL) of the level of the image signal in the structures thereof. Further, in FIGS. 5(a), 5(b), 6(a) and 6(b) mentioned above, the level compensation amount and the backlight compensation amount are so controlled that they change, respectively, in linear depending on the number of pixels being equal or greater than the effective boundary 174, however the present invention should not be restricted only to this. Thus, those compensation amounts may be controlled in a manner of nonlinearity, fitting with the image inputted.

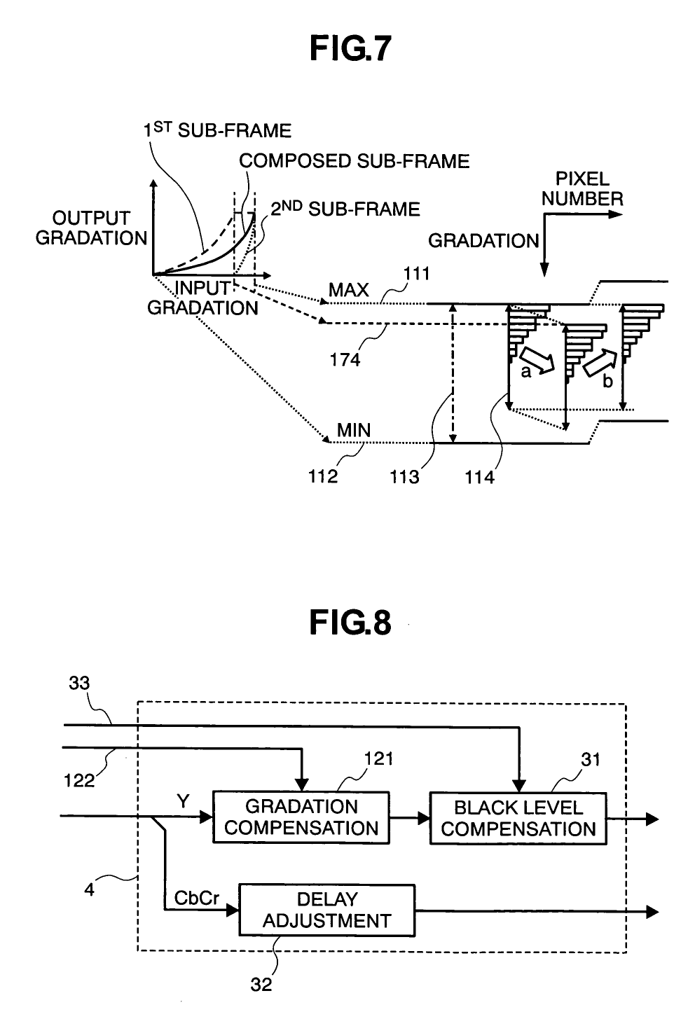

In this manner, according to the present embodiment, the number of pixels is counted up, being equal or greater than the effective boundary 174, from the brightness histogram, which is produced within the histogram detection portion 2, and depending upon the result of that counting, the volume or amount of the level compensation is determined; thereby controlling the gradation of the image signal and the intensity of illumination (i.e., the illuminance) of the backlight. A concept of this control will be explained by referring to FIG. 7 attached. A bar graph in this figure shows the brightness histogram, and in this figure, the vertical axis indicates the gradation while the horizontal axis the number of pixels.

Herein, consideration will be given on the case where determination is made that the image inputted includes the gradations being equal or greater than the effective boundary 174, as is shown in the figure, and that the number of pixels, being equal or greater than the effective boundary 17 in the brightness areas thereof, is equal or larger than a predetermined threshold value, from the result detected from the histogram detection portion 2. In this case, by means of the level compensation portion 4, the compensation is made so that the gradation level of the input image 114 is lowered down to be equal or lower than the effective boundary 174. Thus, the gradation is shifted into a direction of an arrow “a” shown in the figure, and thereby obtaining a compensated image 115. Accordingly, it is possible to keep the total gradation of the compensated image 115 to be equal or lower than the effective boundary 174. As a result of this, for the image near to the maximum (such as, “255”) in the gradation thereof, it is possible to obtain the second sub-frame of the low gradation. Thereafter, since the intensity of illumination from the backlight 11 is heightened or increased by the function of the light source control, then the image formed on the LCD panel visually has a histogram of a display image 116. Thus, this light source control is a control, being substantially equivalent to shifting the histogram of the compensated image 115 into a direction of an arrow “b”. As a result thereof, the maximum gradation within the compensated image 115 can be expressed by the brightness being near to the maximum value thereof, which can be splayed by means of the LCD panel. However, in FIG. 7 mentioned above, width 113 between the maximum brightness value 111 and the minimum brightness value 112 corresponds to a dynamic range of the LCD.

The control mentioned above will be conducted in case when the image signal inputted is the high-gradation image, as was explained previously. The present control will not be conducted, for example, in case when the image inputted does not such the high-gradation image therein, and is mainly constructed with the pixels of middle or intermediate gradations. In this case, only the processes of the normal gradation distributing method will be conducted.

As was mentioned above, with the present embodiment, it is possible to achieve an improvement on the motion blur while suppressing the lowering of the maximum brightness and/or the contract, within the image display apparatus with using such the hold-type display element therein, as the liquid crystal display element, etc., for example. In particular, within the image display apparatus with applying the gradation distributing method mentioned above therein, it is possible to obtain the effect of improving the motion blur even with the high-gradation image of the image signal inputted. And, it is also possible to suppress the lowering of brightness of the display image, even in such the case when heightening or increasing the effect of improving the motion blur.

In the explanation mentioned above, explanation was given on the example where the brightness histogram is applied for the purpose of discriminating the high-gradation image. However, in the place of the brightness histogram, it is also possible to adopt the structures of detecting an averaged brightness level (i.e., APL) of the image, so as to determine the image to be the high-gradation image, when it is equal or greater than a predetermined threshold level in the APL thereof. In this case, also, the similar control to that of the embodiment mentioned above will be conducted thereon, in the case when the image is determined to be the high-gradation image.

Also, in the structures thereof, it is possible to determine an image area on which the histogram be detected, by means of the detection range setup portion 21. In a case where an important or principle portion of the image lies in a center of the display screen, a search region is set up by means of the detection range setup portion 21, within a central portion on the screen. In this case, in particular, on the image where in an object of high gradation is moving within a central portion on a background of relatively low gradation, for example, it is possible to increase the effect of improving the motion blur for that object, much more.

Further, for a telop scrolling of letters, which are high in the brightness thereof, it is sufficient that the detection range be set up in a lower portion of the screen. With this, since the letter telop portion of high gradation can be detected with high accuracy, therefore it is possible to increase the effect of improving the motion blur for that letter telop portion, much more, even if the background is the display of low gradation. However, setup of the histogram detection range by means of the detection range setup portion 21 may be made, automatically, depending on kinds or sorts of the images, or may be set up by a user.

In this manner, with using the detection range setup portion 21, it is possible to obtain an improvement of the motion blur, with high accuracy, for a desired region or area.

### Embodiment 2

Next, explanation will be made on a second embodiment according to the present invention. The present embodiment is characterized by the following aspect, as will be shown in FIG. 8, that a gradation compensation portion 121 is newly provided within the level compensation portion 4, and thereby controlling the gradation compensation portion 121 with using a control signal 122. The structures other than the level compensation circuit 4 are same to that of the first embodiment. Hereinafter, explanation will be given on the details of the present embodiment. However, in FIG. 8, the constituent elements, being similar to those shown in FIG. 4, are given by the same reference numerals, to be omitted from the explanation thereof.

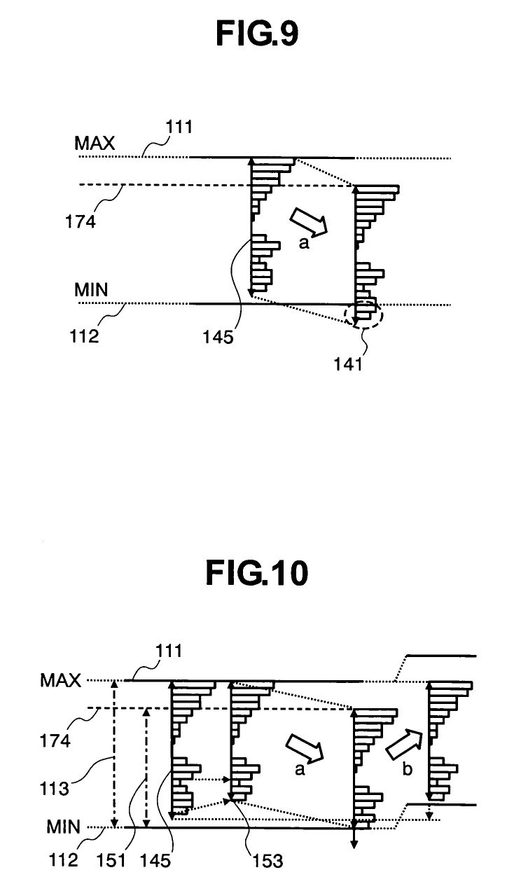

The present embodiment is provided for the purpose of lightening the black defacing caused due to the compensation of black level, which is conducted within the black level compensation portion 31, in particular, in case when amplitude of the input image is expanding from the high gradation to the low gradation. For this reason, within the present embodiment, in front of the black level compensation portion 31 is provided a gradation compensation portion 121 for compressing the signal amplitude. Explanation will be given on the operations thereof, by referring to FIGS. 9 and 10. However, in FIGS. 9 and 10 are also given the same reference numerals to the elements, which are same or similar to those shown in FIG. 7.

As is shown in FIG. 9, consideration will be given on the case of inputting the image signal 145, in which number of pixels are within a wide gradation range covering from the high gradation to the low gradate. Such the image signal 145 is determined to be the high-gradation image within the histogram detection portion 2 and the image determination portion 3. And, the black level thereof is shifted by means of the level compensation portion 4, as is indicted by an arrow “a”, so that the gradation of the image signal 145 comes to be equal or less than the effective boundary 174. As a result thereof, as is shown in FIG. 9, a low-gradation portion 141 (i.e., the portion surrounded by a circle of dotted line) thrusts into a minimum value 112 of the reproducible gradation of LCD panel, thereby generating the above-mentioned compression gradation level 191. For preventing this, according to the present embodiment, compressing is made upon the amplitude of the image signal by means of the gradation compensation portion 121, when the image signal inputted is the high-gradation image.

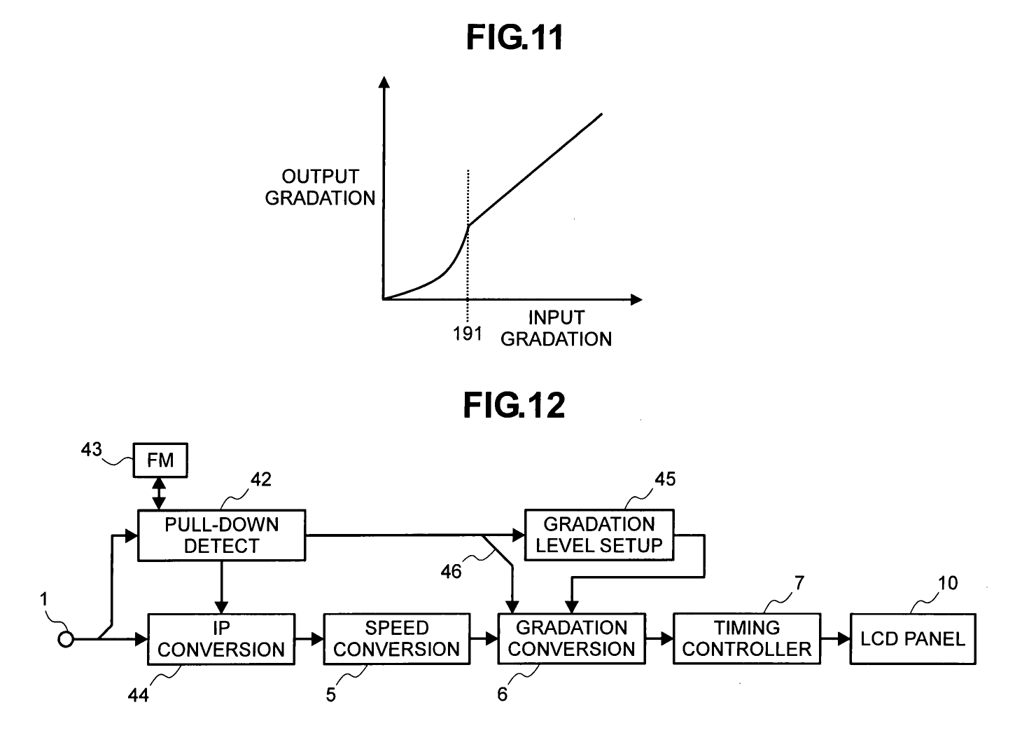

A manner of control within the present embodiment will be shown in FIG. 10. The image determination portion 3 determines on whether the number of pixels within the low-gradation area is equal or greater than a predetermined rate, or not, from the brightness histogram of the image signal 145, which is detected by the histogram detection portion 2. If so, then the image determination portion 3 outputs the control signal 122 to the gradation compensation portion 121. Upon receipt of the control signal 122, the gradation compensation portion 121 operates to compress the amplitude of that image signal 145. Within the present embodiment, compression is made on only the low-gradation area of the image signal 145, so that the total amplitude of the image signal 145 is restored within an improvable area 151, which is determined by the effective boundary 174 and the minimum value 113 of the reproducible gradation mentioned above. An example of the characteristics of gradation compensation within this gradation compensation portion 121 is shown in FIG. 11, for example. As is shown in FIG. 11, among of those within the image signal inputted, the gradations being equal or less than a predetermined compression gradation level 191 are lowered (or compressed) in the nonlinear manner. Herein, it is so determined that the gradations being equal or greater than the above-mentioned compression gradation level 191 are not converted in the gradation thereof (i.e., an input gradation:an output gradation=1:1). The above-mentioned compression gradation level 191 may be determined arbitrarily. In this manner, compressing the gradations within the low-gradation area of the image signal in advance, before the black level is lowered down by through the black level compensation portion 31, prevents the low-gradation area of the image signal from becoming to be equal or lower than the minimum value 112 of the reproducible gradation through the lowering process of the black level.

In the present embodiment, not being compressed, but the components within the high-gradation portion are as they are, therefore it is possible to prevent the contract from being lowered through the gradation conversion. However, in the present embodiment, explanation was given that the compression is made on only the low-gradation area of the image signal 145, but the compression may be made upon the entire of the image signal 145. Or, a ratio of compression may be set different from, between the low-gradation area and the high-gradation area, on a boarder of the compression gradation level 191.

Through such processing, the gradation compensation portion 121 produces a compression signal 153, to be outputted into the black level compensation portion 31. Processing thereafter, i.e., process within the black level compensation portion 31 (e.g., the process of the arrow “a”) and the process within the light source control portion 8 are same to those of the first embodiment (the processes shown in FIG. 7) mentioned above.

As was mentioned above, according to the present embodiment, compression is made upon the low-gradation portion of the amplitude of the image signal inputted, being equal or lower than the predetermined gradation level, before compensation of the black level. For this reason, it is possible to lighten the black defacing due to the compensation on the black level, even in the case where the image signal inputted is a wide-amplitude signal, the amplitude of which extends widely from the high gradation to the low gradation. Accordingly, according to the present embodiment, it is possible to increase or heighten the effect of improving the motion blur within the gradation distributing method, while lightening the black defacing.

### Embodiment 3

Next, explanation will be made about a third embodiment of the present invention. FIG. 12 is a block diagram for showing an example of the structures of the image displaying apparatus, according to the third embodiment of the present invention. In this figure, the constituent elements similar or same to those of the first embodiment shown in FIG. 1 are attached with the same reference numerals, and thereby being omitted from the detailed explanations thereof.

The present embodiment is provided for suppressing the flicker and/or motion judder in case when conducting the signal processing in accordance with the gradation distributing method mentioned above, in particular, upon the image signal, which is processed with the 2-3 pull-down or the 2-2 dull-down, such as, movie, CG or animation, for example, (hereinafter, being called by a “pull-down signal”, collectively), as the input image. Before giving explanation about the present embodiment, a reason will be explained, of generating the flicker and/or motion judder when conducting the signal processing in accordance with the gradation distributing method upon the pull-down signal.

For example, when conducting the signal processing in accordance with the gradation distributing method as was mentioned, on the 2-2 pull-down image signal, repeating the same image two (2) times continuously, such as, A, A, B, B . . . , for example, then the following train of sub-frames:
A(H), A(L), A(H), A(L), B(H), B(L), B(H), B (L) . . .
   wherein, “H” indicates a bright gradation, while “L” a dark gradation, in the above frame rain.

Since the liquid crystal display is an element of the hold-type, then normally, the flicker is not remarkable. However, on such the sub-frame train as was mentioned above, A(L: dark) data near to zero (0) gradation is written into the liquid crystal display element between two (2) pieces of the sub-frames A(H: bright). Thus, the sub-frames A(H: bright) are displayed, repeatedly, separated in the timing, and therefore, it can be considered that it is recognized to be the flicker.

Also, in the similar manner, A(L: dark) data near to zero (0) gradation is written into the liquid crystal display element, when exchanging the original frame, i.e., when a frame “A” is switched to a frame “B”. It can be considered, with this, the difference in images between the original frames “A” and “B” comes to be large in a way of viewing thereof. Thus, approaching of a response of the display element near to an impulse response makes the motion judder recognizable, being emphasized. Actually, it is confirmed that the same phenomenon can be seen on a CRT of the impulse drive. It can be considered that, with a multiple effect of the flicker and the motion judder, they are emphasized with each other, to be recognized as the deterioration of picture quality. Although the explanation was given by taking the example of the time when inputting the 2-2 pull-down image in the above; however, it can be considered, that also the similar reduction may be generated when inputting the 2-3 pull-down signal.

The present embodiment is provided for reducing such the deterioration of picture quality. In FIG. 12, a pull-down signal 41 inputted is provided to a pull-down detection portion 42. The pull-down detection portion 42 detects on whether the image signal inputted is the pull-don signal or not. For example, the pull-down detection portion 42 detects the difference between the fields, with using a field memory 43, and determines on whether the signal is the 2-2 pull-down signal or the 2-3 pull-down signal, through discriminating the timing when that difference comes to be zero (0). Regarding the details of this will be omitted herein, since not being a gist of the present embodiment.

Within the pull-down detection portion 42, 2-2 pull-down determination signal and a phase signal, or 2-3 pull-down determination signal and a phase signal are provided, to be outputted to a progressive conversion portion 44 and a gradation level setup portion 45. Within the progressive conversion portion 44 is conducted a high-quality interlace/progressive (non-interlace) conversion, with using the determination signal and the phase signal supplied from the pull-down detection portion 42 mentioned above. The signal from the progressive conversion portion 44 is supplied to the speed conversion portion 5. The speed conversion portion 5 conducts the speed conversion upon the output signal of the progressive conversion portion 44; thereby producing the first and second sub-frames, as was explained in the first embodiment. Within the gradation level setup portion 45 is determined a level of distributing the gradations for each of the first and second sub-frames produced within the speed conversion portion 5, depending on the 2-3 pull-down signal, the 2-2 pull-down signal, and signal other than those, for example. In the gradation conversion portion 6, conversion is made on the gradations of the first and second sub-frames, which are produced within the speed conversion portion 5, depending upon the setup of gradation made within the gradation level setup portion 45 mentioned above. The signal to be sent (i.e., the sub-frame train), on which the gradation conversion is made within the gradation conversion portion 6, is supplied to the LCD panel 10 through the timing controller 7 in the similar manner to the first embodiment as was mentioned. The LCD panel 10 displays the image corresponding to the sub-frame train supplied from the timing controller 7.

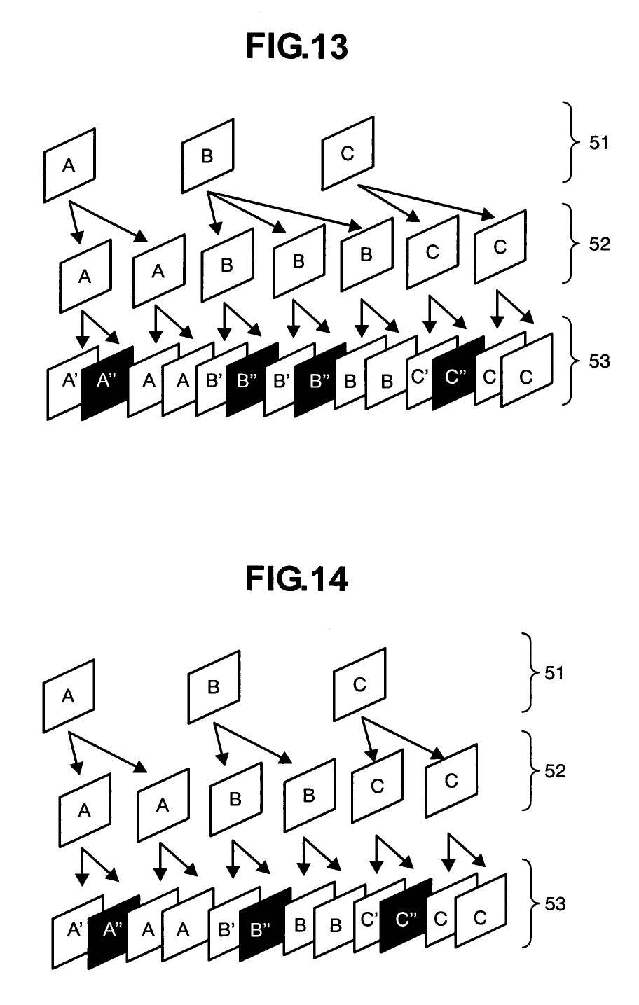

Next, explanation will be made on an example of the operations in the gradation level setup portion 45, by referring to FIGS. 13 and 14 attached herewith. Those FIGS. 13 and 14 are showing the relationships between the image (i.e., a base image) before the pull-down processing, the original frame of the pull-down signal, and the sub-frame train, which is produced in the present embodiment. In those FIGS. 13 and 14, the base image 51 depicts the image of the movie or the like, for example, and it has a frame frequency 24 kHz. Through conducting the pull-down processing on this, for example, on a side of a broadcasting station, etc., a pull-down signal 52 of the frame frequency 60 kHz. From this pull-down signal 52 is produced the sub-frame train of frame frequency 120 kHz, by means of the image displaying apparatus according to the present embodiment. However, FIG. 13 shows an example of processing onto the 2-3 pull-down signal, while FIG. 14 the processing onto the 2-2 pull-down signal.

As was mentioned previously, in accordance with the gradation distributing method, data of the sub-frame of 0 (black) gradation is written into the LCD panel 10, at the exchanging portion of the original frame (i.e., at the portion where the original frame is switched from “A” to “B”). For this reason, there is a possibility that the motion judder being emphasized is recognized by a user. Then, according to the present embodiment, as be shown in FIGS. 13 and 14, no such data of the sub-frame of 0 (black) gradation is written at the exchanging portion of the original frame, but the setup is made of repeating the original frame to be the sub-frames. Thus, according to the present embodiment, the sub-frame train, which is produced from the 2-3 pull-down signal comes to be the following:
A′(H), A″(L), A(O), A(O), B′(H), B″(L), B′(H), B″(L), B(O), B(O) . . .
   wherein, “H” indicates the bright gradation, “L” the dark gradation, and “O” the gradation equal to that of the original frame, in the above frame rain.

Also, in the present embodiment, the sub-frame train, which is produced from the 2-2 pull-down signal comes to be the following:
A′(H), A″(L), A(O), A(O), B′(H), B″(L), B(O), B(O) . . .

However, the exchanging portion of the original frame in the 2-3 pull-down signal can be acknowledged by means of the pull-down detection portion 42, using the pull-down phase signal 46. The acknowledgement of the 2-2 pull-down signal can be made in the similar manner.

As was mentioned above, it is possible to suppress the emphasis of the motion judder, by fitting the gradation level of the sub-frames, at the frame exchange portion on the input of the pull-down signal.

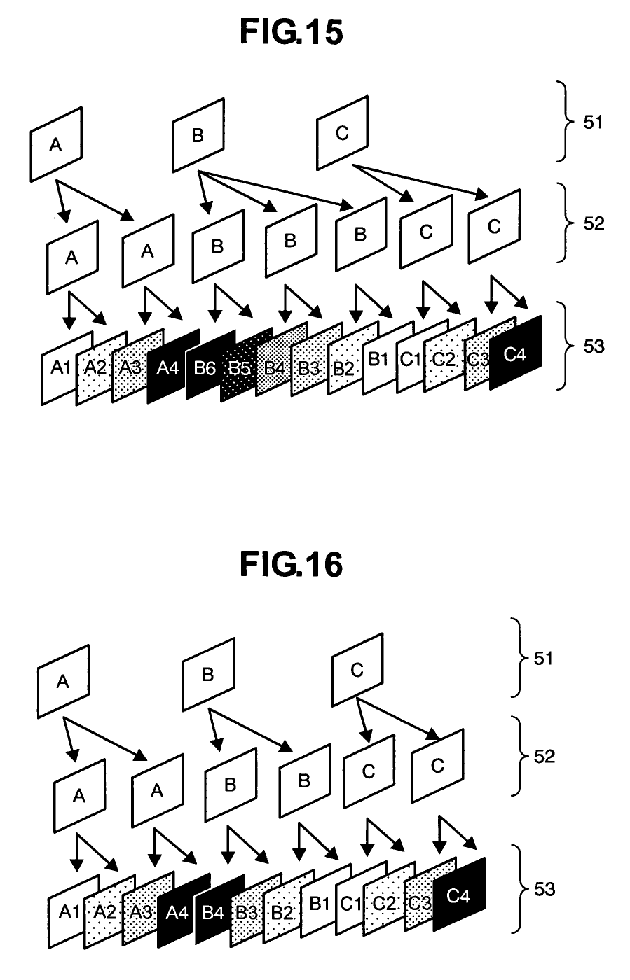

FIG. 15 is a view for explaining about the other operations of the gradation level setup portion 45 shown in FIG. 12. In this FIG. 15, the gradation level conversion data is exchanged, fitting with the frequency of the pull-down. Thus, a first group is built up with four (4) pieces of the sub-frames, at the portion repeating the two (2) frames, while a second group is built up with six (6) pieces of the sub-frames, at the portion repeating the three (3) frames. And, for each group of the respective sub-group, the gradation data conversion is conducted on each sub-frame thereof. However, in this instance, regarding the exchange portion of frames, the setup is made of repeating the original frame, as was mentioned about the example shown in FIG. 13.

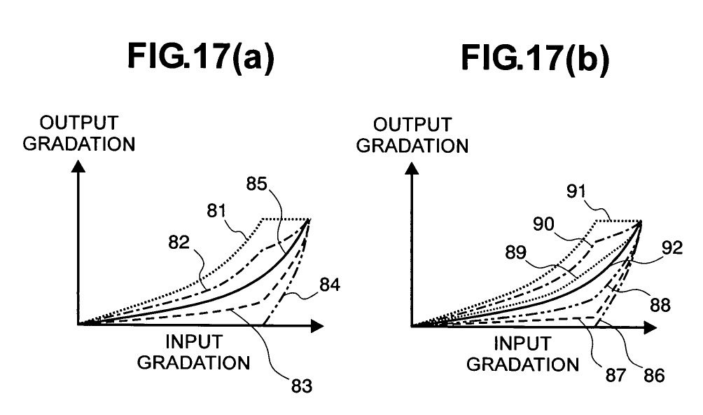

FIGS. 17(a) and 17(b) show an example of the characteristics of gradation conversion data, for conducting the gradation conversion upon the sub-frames shown in FIG. 15. In particular, FIG. 17(a) shows the gradation conversion characteristic in the case of repeating the two (2) frames (i.e., the first group including four (4) pieces of the sub-frames), and FIG. 17(b) the gradation conversion characteristic in the case of repeating the three (3) frames (i.e., the first group including six (6) pieces of the sub-frames), respectively. In this FIG. 17(a), a reference numeral 81 depicts the characteristic curve of the first sub-frame, a reference numeral 82 the characteristic curve of the second sub-frame, a reference numeral 83 the characteristic curve of the third sub-frame, a reference numeral 84 the characteristic curve for use of the fourth sub-frame, and a reference numeral 85 the characteristic curve of a composed frame when combining those first to fourth sub-frames, respectively. As is apparent from the figure, according to the present embodiment, the gradations are increased or heighten in the order, i.e., the first sub-frame, the second sub-frame, the third sub-frame, and the fourth sub-frame, in the first group. In the similar manner, in this FIG. 17(b), a reference numeral 86 depicts the characteristic curve of the first sub-frame, a reference numeral 87 the characteristic curve of the second sub-frame, a reference numeral 88 the characteristic curve of the third sub-frame, a reference numeral 89 the characteristic curve for use of the fourth sub-frame, a reference numeral 90 the characteristic curve for use of the fifth sub-frame, a reference numeral 91 the characteristic curve for use of the sixth sub-frame, and a reference numeral 92 the characteristic curve of the composed frame when combining those first to sixth sub-frames. As is apparent from the figure, according to the present embodiment, the gradations are increased or heighten in the order, i.e., the first sub-frame, the second sub-frame, the third sub-frame, the fourth sub-frame, the fifth sub-frame, and the sixth sub-frame, in the second group.

With such the setup of the gradations in this manner, almost no difference is generated in the brightness, between a final sub-frame (i.e., the fourth sub-frame) of the first group and a starting sub-frame (i.e., the first sub-frame). Therefore, a large difference is not generated in the brightness, at the exchange portion of the original frame, and thereby suppressing such the motion judder and/or the flicker as was mentioned in the above.

In FIG. 17, during the time-period of the first group, the value obtained through integration of two (2) frames of the image data is equal to the value obtained through integration of four (4) pieces of sub-frames, thereby keeping the display brightness thereof. Also, in the similar manner to the time-period of the second group, the value obtained through integration of three (3) frames of the image data is equal to the value obtained through integration of six (6) pieces of sub-frames.

As was mentioned above, according to the present embodiment, when inputting the 2-3 pull-down signal, grouping is made upon the four (4) pieces of the sub-frames, corresponding to the repeating portion of two (2) frames, to be the first group, and also grouping is made upon the six (6) pieces of the sub-frames, corresponding to the repeating portion of three (3) frames, to be the second group. And, in each of the first and second groups, the gradation conversion is made upon each sub-frame thereof, respectively. For this reason, even in case when the sub-frame is produced from the 2-3 pull-down signal in accordance with the gradation distributing method, it is possible to suppress the deterioration of picture quality, such as, the flicker and the motion judder emphasis.

Also, when inputting the 2-2 pull-down signal, as is shown in FIG. 16, grouping is made upon each of the four (4) pieces of the sub-frames, corresponding to the repeating portion of two (2) frames, and conversion is made upon the gradation of each of the sub-frames within this group, respectively. In this instance, setup is so made that difference is hardly generated in the gradation between the final sub-frame of a certain group and the starting sub-frame within the next coming group. Thus, within the certain group, the gradations of the sub-frames are increased or heighten in the order, the first sub-frame, the second sub-frame, the third sub-frame and the fourth sub-frame, while within the next coming group, the gradations are lowered in the order, the first sub-frame, the second sub-frame, the third sub-frame and the fourth sub-frame. In this instance, the same characteristic may be used to be the gradation conversion characteristics for both the certain group and the next coming group. Also, the characteristics may be used, separately, for each of the groups.

With this example, it is possible to suppress the deterioration of picture quality, such as, the flicker and the motion judder emphasis, even when producing the sub-frames from the 2-2 pull-down signal in accordance with the gradation distributing method.

The present invention may be embodied in other specific forms without departing from the spirit or essential feature or characteristics thereof. The present embodiment(s) is/are therefore to be considered in all respects as illustrative and not restrictive, the scope of the invention being indicated by the appended claims rather than by the forgoing description and range of equivalency of the claims are therefore to be embraces therein.

What is claimed is:

1. An image displaying apparatus, comprising:
a sub-frame producing portion, which is configured to produce a first sub-frame and a second sub-frame, which is lower in gradation thereof than said first sub-frame, from one (1) frame of image on an image signal inputted; and
a level compensation portion, which is configured to lower a gradation level of said image signal inputted, in case when the gradation of said image signal inputted is equal or greater than a predetermined value;
wherein said sub-frame producing portion produces the first and the second sub-frames with using the image signal, which is lowered in the gradation level thereof by means of said level compensation portion, when the gradation of said image signal inputted is equal or greater than the predetermined value.

2. The image displaying apparatus, as described in the claim 1, wherein said level compensation portion lowers the gradation level of said image signal inputted, by lowering a black level of said image signal inputted, when the gradation of said image signal inputted is equal or greater than the predetermined value.

3. The image displaying apparatus, as described in the claim 1, wherein said level compensation portion lowers the gradation level of said image signal inputted, by compressing an amplitude level of said image signal inputted, when the gradation of said image signal inputted is equal or greater than the predetermined value.

4. The image displaying apparatus, as described in the claim 1, wherein said image displaying apparatus is a liquid crystal displaying apparatus of hold-type of forming an image through modulation of a light from a light source, and further comprising:
a light source control portion, which is configure to increase an intensity of illumination of said light source, when the gradation of said image signal inputted is equal or greater than the predetermined value.

5. The image displaying apparatus, as described in the claim 1, wherein said level compensation portion lowers the gradation level of said image signal inputted, so that the gradation of said input comes to be equal or lower than a predetermined gradation.

6. An image displaying apparatus, comprising:
a liquid crystal displaying portion, which is configured to modulate a light from a light source;
a sub-frame producing portion, which is configured to produce a first sub-frame and a second sub-frame, which is lower in gradation thereof than said first sub-frame, from one (1) frame of image on an image signal inputted, to be supplied to said liquid crystal displaying portion;
a level compensation portion, which is configured to lower a gradation level of said image signal inputted, in case when said image signal inputted is a high-gradation image, gradation of which is equal or higher than a predetermined value; and
a light source control portion, which is configure to control an intensity of illumination from said light source;
wherein said sub-frame producing portion produces the first and the second sub-frames with using the image signal, which is lowered in the gradation level thereof by means of said level compensation portion, when said image signal inputted is the high-gradation image, and
said light source control portion controls so that the intensity of illumination from said light source is increased, when said image signal inputted is the high-gradation image.

7. The image displaying apparatus, as described in the claim 6, further comprising:
a histogram detection portion, which is configure to detect a histogram indicative of frequencies of appearances, for each of plural numbers of gradation areas, during a predetermined time-period, from said image signal inputted; and
an image determination portion, which is configured to determine on whether the image signal inputted is said high-gradation image or not, from the histogram detected by said histogram detection portion;
wherein said image determination portion determines that said image signal inputted is said high-gradation image, when the frequency of appearances in a predetermined gradation area is equal or greater than a predetermined threshold value on said histogram, and
said level compensation portion and said light source control portion are controlled depending upon a result of determination of said image determination portion.

8. The image displaying apparatus, as described in the claim 7, further comprising:
a detection range setup portion, which is configured to set up an image area where said histogram should be detected;
wherein said histogram is detected within a detection range, which is determined by said detection range setup portion.

9. The image displaying apparatus, as described in the claim 6, further comprising:
an APL detection portion, which is configured to detect an averaged brightness level during a predetermined time-period, from said image signal inputted;
an image determination portion, which is configured to determine on whether the image signal inputted is said high-gradation image or not, from the averaged brightness level detected by said APL detection portion;
wherein said image determination portion determines that said image signal inputted is said the high-gradation image, when said averaged brightness level is equal or greater than a predetermined value, and
said level compensation portion and said light source control portion are controlled depending upon a result of determination of said image determination portion.

10. The image displaying apparatus, as described in the claim 9, further comprising:
a detection range setup portion, which is configured to set up an image area where said averaged brightness level should be detected;
wherein said averaged brightness level is detected within a detection range, which is determined by said detection range setup portion.

11. An image displaying apparatus, comprising:
a sub-frame producing portion, which is configured to produce a plural number of sub-frames, differing in gradation from each other, from one (1) frame of image on an image signal inputted; and
a pull-down detection portion, which is configured to determine on whether said image signal inputted is a signal treated with 2-3 pull-down process or with 2-2 pull-down process;
wherein gradation levels are made equal to each other, between the sub-frames at exchange portions of the frames of said image signal inputted, among the plural number of the sub-frames, which are produced within said sub-frame producing portion, when determining that the image signal inputted is the signal treated with said pull-down process by said pull-down detection portion.

12. The image displaying apparatus, as described in the claim 11, further comprising:
a pull-down gradation level setup portion;
wherein grouping is made on the plural number of sub-frames, which are produced within said sub-frame producing portion, into four (4) pieces of sub-frames, and
said pull-down gradation level setup portion sets up a gradation level for each of said four (4) pieces of the grouped sub-frames, when said image signal inputted is determined to be the signal treated with the 2-2 pull-down process by said pull-down detection portion.

13. The image displaying apparatus, as described in the claim 12, wherein said pull-down gradation level setup portion determines the gradations for said four (4) pieces of the grouped sub-frames, so as to change in a step-like manner, and makes gradation levels at exchange portions of the frames being equal to each other.

14. The image displaying apparatus, as described in the claim 11, further comprising:
a pull-down gradation level setup portion;
wherein the plural number of sub-frames, which are produced within said sub-frame producing portion, are divided into a first group, by grouping every four (4) pieces of sub-frames, and a second group, by grouping every six (6) pieces of sub-frames, and
said pull-down gradation level setup portion sets up gradation levels, for each of the four (4) pieces of sub-frames included within said first group, and for each of the six (6) pieces of sub-frames included within said second group, when said image signal inputted is determined to be the signal treated with the 2-3 pull-down process.

15. The image displaying apparatus, as described in the claim 11, wherein said pull-down gradation level setup portion determines gradation levels for said four (4) pieces of the grouped sub-frames included within said first group and for the six (6) pieces of the sub-frames included within said second group, so as to change in a step-like manner, respectively, and makes gradation levels at exchange portions of the frames being equal to each other.
